(19) United States
(12) Patent Application Publication
(10) Pub. No.: US 2014/0263656 A1
(43) Pub. Date: Sep. 18, 2014

(54) TRANSFERABLE FILM INCLUDING LOGIC CIRCUIT, AND METHODS FOR PROVIDING TRANSFERABLE FILM

(71) Applicant: ILLINOIS TOOL WORKS INC, GLENVIEW, IL (US)

(72) Inventors: John H. Schneider, FRANKFORT, IL (US); WILLIAM A. HERRING, VALPARAISO, IN (US); JOSEPH M. FISHER, CHEEKTOWAGA, NY (US); DEBORAH ASHTON, TONAWANDA, NY (US); MICHAEL B. COLELLA, SOUTHINGTON, CT (US)

(73) Assignee: ILLINOIS TOOL WORKS INC, GLENVIEW, IL (US)

(21) Appl. No.: 13/838,593

(22) Filed: Mar. 15, 2013

(51) Int. Cl. G06K 19/08; B32B 37/26

(52) U.S. Cl. CPC G06K 19/083; B32B 37/26
USPC 235/488; 156/60

(57) ABSTRACT

A transferable film includes a carrier layer and an intermediate portion. The carrier layer is configured to receive one or more additional layers and to be releasable from the one or more additional layers temporally proximate to an application of the transferable film to an object. The intermediate portion includes the one or more additional layers and a circuit. The one or more additional layers include a graphics layer. The intermediate portion is configured for application thereto of an adhesive layer, whereby the intermediate portion is configured to be interposed between the carrier layer and the adhesive layer. The adhesive layer is configured to adhere to the object for the application of the transferable film to the object.

### BACKGROUND

The subject matter described herein generally relates to transferable films and systems and methods for providing transferable films.

### BRIEF SUMMARY

One or more embodiments described herein provide for a transferable film (and/or method for providing the same) that includes a circuit portion. For example, embodiments provide a heat transferable film with an integrated circuit embedded therein.

### BRIEF DESCRIPTION OF THE DRAWINGS

The present inventive subject matter will be better understood from reading the following description of non-limiting embodiments, with reference to the attached drawings, wherein below:

FIG. 1 is a schematic view of one embodiment of a transferable film;

FIG. 2 is a sectional view of a transferable film in accordance with an embodiment;

FIG. 3 is a flowchart of one embodiment of a method for providing a transferable film including a circuit portion in accordance with an embodiment;

FIG. 4 is a flowchart of one embodiment of a method for transferring a film including a circuit portion to an object;

FIG. 5 is a schematic view of an object having a transferable film applied thereto in accordance with an embodiment.

### DETAILED DESCRIPTION

In accordance with one or more embodiments described herein, a transferable film including a circuit portion and methods for providing and/or applying a transferable film including a circuit portion are disclosed. For example, the transferable film may be configured as a heat transferable film having a carrier layer, at least one of an optically readable code or graphics layer, a circuit portion (which may be configured as one or more layers or sub-layers), and an adhesive layer. The carrier layer may be heat releasable and removed when the film is applied to an object, such as a box, envelope, package, product, or the like. In some embodiments, the transferable film is configured as a heat transferable film (e.g., configured to be applied via a combination of heat, time, and pressure, which may be facilitated via a press and/or roller, or the like). In some embodiments, the transferable film is configured as a hot stamped foil for application to an object via a hot stamping process utilizing a die. The optically readable code in various embodiments may be configured to correspond to identification information of the circuit portion. As used herein, an optically readable code may be understood as a tangible representation of information that may be optically scannable, viewable, visually determinable, or the like, by an observer having the optically readable code within a field of view and/or a machine such as a bar code reader or the like. Examples of optically readable code include a printed serial code, a bar code such as a Universal Product Code (UPC), a quick response (QR) or other matrix-type bar code, or the like. Transferable films provided by various embodiments may be utilized, for example, as labels for products or product packaging providing for identification and tracking of products or packaging through various stages of manufacture, warehousing, distribution, sale, delivery, or the like; labels for packages to be shipped allowing for identification and tracking of packages being shipped; or the like.

In various embodiments, the circuit portion may include a logic circuit (e.g., an integrated circuit (IC)) that is coupled or otherwise operably connected with additional components as part of the circuit portion. Such an IC may be formed as thin flexible IC, for example as a screen printed circuit on a flexible substrate, such as a polyester. As used herein, an integrated circuit may be understood as a circuit including one or more of transistors, resistors, capacitors, or logic gates, with the logic gates configured to perform logical operations on one or more logic inputs and produce corresponding logic outputs. A circuit portion, as used herein, may be understood as a logic circuit coupled or otherwise operatively connected to one or more other components that provide functionality. For example, a circuit portion may include a logic circuit include logic identifying one or more of the IC, a film within which the IC is embedded, or an object associated therewith, and a radiofrequency identification (RFID) antenna. An operator may be able to acquire identification information corresponding to the IC, film, and/or associated object from the logic circuit via the RFID antenna. Thus, an operator may be provided with a reliable and convenient way to identify an object (e.g., an object to which a transferable film including an IC having an RFID antenna has been applied).

Use of an IC for identification provides just one example of potential types of IC's or uses for IC's embedded within a transferable film, as other uses of IC's may be employed, for example to provide improved interactivity between a transferable film and an operator. Embodiments provide for cost effective mounting of an integrated circuit to a package or product. Embodiments provide for flexibility, functionality, and/or performance of transferable films by the addition, incorporation, or embodiment of a circuit portion to the transferable film. For example, embodiments provide for a label that may be heat transferable to a package or product that provides for improved readability or other acquisition of identification information. For example, identification information may be acquired more quickly, more reliably, or the like. Embodiments provide for a transferable and flexible multilayered film with a circuit portion embedded therein which may be conveniently, reliably, and economically applied, such as by a heat transfer process. In various embodiments, the capability to digitally print short-run late-stage decorations such as logos or other graphics, may be provided or accommodated. Embodiments also provide effective visual concealment of a circuit portion disposed within a transferable film, for example via the use of a graphics layer disposed above the circuit portion. Various embodiments may provide for convenient mounting of a circuit portion to products, packages, or surfaces thereof having round, curved, angled, uneven, irregular, or otherwise contoured portions.

FIG. 1 shows a schematic view of a plurality of layers that may be combined to form a transferable film 100 that may be applied to an object 101. Generally, in the depicted embodiment, the transferable film 100 includes a carrier layer 102, an adhesive layer 104, and an intermediate portion 106 interposed between the carrier layer 102 and the adhesive layer 104. The transferable film 100 may be configured to be heat transferable by a heat transfer film or by a hot stamp foil process. The carrier layer 102 is configured to be releasable from the transferable film 100 upon application of the transferable film 100 to a target object, such as a box, package, envelope, container, sheet, or the like. The adhesive layer 104 is configured to be oriented toward an object receiving the transferable film 100 and to be positioned adjacent to the object after application of the transferable film. The adhesive layer 104 is configured to adhere the intermediate portion 106 to the object receiving the transferable film 100. The depicted intermediate portion 106 includes a circuit portion 118. The circuit portion 118, for example, may include an IC including a logic circuit operably connected with one or more additional components, such as an RFID antenna. Upon, during, or after application of the transferable film 100 to a desired target object, the carrier layer 102 may be released or removed from the transferable film, leaving the adhesive layer 104 and the intermediate portion 106 adhered or otherwise joined to the object, with an outermost portion or layer of the intermediate portion 106 defining an exterior boundary of the transferable film 100 after application of the transferable film 100 to an object and removal of the carrier layer 102. The transferable film 100 may be configured to be flexible, and may be mounted to products, packages, or surfaces thereof having round, curved, angled, uneven, irregular, or otherwise contoured portions.

It should be noted that FIG. 1 (nor other Figures described herein) is not intended as a scale representation. Instead, FIG. 1 (and other Figures described herein) are intended as schematic in nature and for clarity of understanding of general principles of various embodiments. For example, layers may vary in thickness or number, different layers may have different thicknesses than other layers, one or more layers may include sub-layers, one or more layers may be combined, one or more layers may be split into separate layers, or the like. Further, various layers may provide differing areas of coverage. For example, a given layer may not cover an entire area covered by a different layer. In some embodiments, one or more layers may be disposed at a same or similar depth in the transferable film, such that given layers may have partially or completely overlapping depths along the thickness of the transferable film 100. Further still, in various embodiments, certain layers depicted in FIG. 1 may not be included, and/or additional layers or sub-layers may be provided.

In the illustrated embodiment, the transferable film includes the carrier layer 102, a top coat layer 110, an optically readable identification layer 112, a graphics layer 114, a circuit adhesive layer 116, the circuit portion 118, and the adhesive layer 104. Generally, the top coat layer 110 is configured to provide protection to layers and/or components positioned beneath (e.g., closer to the object 101 when the transferable film 100 is applied to the object 101) the top coat layer 110. The optically readable identification layer 112 may be configured to provide a number or other identification code that is optically readable. The graphics layer 114 may be configured to provide an informative and/or decorative display, and/or to conceal the circuit portion 118 from view. The circuit adhesive layer 116 is configured to adhere the circuit portion 118 to another aspect of the intermediate portion 106, such as the graphics layer 114. The circuit portion 118 includes a circuit configured to provide a desired functionality to the transferable film 100. For example, the circuit portion 118 may provide identification information regarding a circuit, a film (which may be used, for example, as a label), or an object to which the film is applied. The adhesive layer 104 may be configured to secure, affix, or otherwise adhere the transferable film 100 to the object 101.

The carrier layer 102 may be configured to receive one or more additional layers, directly or indirectly. In the illustrated embodiment, the carrier layer 102 is configured to be releasable from the one or more additional layers temporally proximate to an application of the transferable film to an object. Thus, the transferable film 100 may be considered as being transferred from the carrier layer 102 to the object 101. Temporally proximate may be understood as meaning, for example, at or near in time. For example, the release of the carrier layer 102 may overlap in time with the application of the transferable film 100 to an object, or as another example, may occur shortly thereafter. The carrier layer 102 is configured to provide a substrate for construction of the transferable film 100, with additional layers or sublayers affixed to the carrier layer 102, and/or to a layer or sub-layer that has already been affixed to the carrier layer 102. The carrier layer 102 may be configured as a film. The carrier layer 102 may be made from, for example, a polymeric film. For example, a polyethylene terapththalate (PET) such as biaxially-oriented polyethylene terephthalate (BoPET) may be used. BoPET may be understood as a polyester film made from stretched PET.

The top coat layer 110 in the illustrated embodiment is the portion of the intermediate portion 106 that is positioned immediately adjacent to the carrier layer 102. Thus, the top coat layer 110 of the depicted embodiment is configured to be the outermost portion (e.g., closest to an observer or farthest from the object to which the transferable film 100 is affixed) of the transferable film 100 after application to the object 101 and removal of the carrier layer 102. In some embodiments, for example certain embodiments including an optically readable identification layer 112 and/or a graphics layer 114, the top coat layer 110 may be substantially transparent to minimize or reduce any effect the top coat layer 112 may have on the visual appearance of the optically readable identification layer 112 and/or the graphics layer 114. In other embodiments, for example certain embodiments that do not have an optically readable identification layer 112 or a graphics layer 114, the top coat layer 110 may be configured to be partially or entirely opaque to help shield the circuit portion 118 from view. Generally, the top coat layer 110 is configured to provide protection from exposure to other aspects of the intermediate portion 106. In various embodiments, a release coat layer (see FIG. 2) may be interposed between the carrier layer 102 and the top coat layer 110. In some embodiments, the top coat layer 110 may have release properties to assist in the removal of the carrier layer 102 from the top coat layer 110. In alternate embodiments, the top coat layer 110 may also be releasable and/or be part of the carrier layer 102. In still other embodiments, the top coat layer 110 may not be present.

In the illustrated embodiment, the optically readable identification layer 112 is positioned adjacent to the top coat layer 110. As shown in FIG. 1, the optically readable identification layer 112 is disposed immediately beneath the top coat layer 112. In the embodiment depicted in FIG. 1, the optically readable identification layer 112 covers an area of the top coat layer 110 that is less than the entire area of the top coat layer 110. Thus, additional layers, such as the graphics layer 114, may overlap partially or entirely with the optically readable identification layer 112 along the depth of the transferable film 100. With respect to other aspects of the intermediate portion 106 (e.g., circuit portion 118, all or a portion of the graphics layer 114), the optically readable identification layer 112 may be positioned at a relatively higher position along the thickness or depth of the transferable film 100 (e.g., away from the object 101 and closer to an observer) to allow for reduction or elimination of any blockage or obscuring of the optically readable identification layer 112 or a portion thereof to an observer. An observer may be understood, for example, to include one or more of a human operator visually inspecting the transferable film 100 (or the object 101 to which the transferable film 100 has been applied) or a machine configured to optically scan the transferable film 100 (or the object 101 to which the transferable film 100 has been applied), such as a bar code reader, a camera (and/or processor configured to analyze an image provided by a camera), or the like.

In the illustrated embodiment, the optically readable identification layer 112 is configured to include an optically readable code configured to communicate identification information. The optically readable code in various embodiments may be configured to correspond to identification information of one or more of a circuit, a film in which the logic circuit is embedded, or an object to which a film in which a circuit is embedded has been applied or is to be applied to. As used herein, an optically readable code may be understood as a tangible representation of information that may be optically scannable, viewable, visually determinable, or the like, by a human observer having the optically readable code within a field of view and/or a machine such as a bar code reader, camera, or the like. The optically readable identification layer 112 in various embodiments may include an optically readable code that includes one or more of a readable printed alpha-numeric serial number or part number, machine readable bar code, machine readable QR code, or the like.

The graphics layer 114 in the illustrated embodiment is positioned beneath (e.g., closer to the object 101 and farther from an observer) the top coat layer 110 and the optically readable identification layer 112. The graphics layer 114 may include one or more of a logo, a title, a slogan, a product name, a part number, a border, or the like configured to be displayed to an observer of the transferable film 100 (e.g., an observer of an object to which the transferable film 100 has been applied). The graphics layer 114 may be configured to provide a decorative and/or an informative display to an observer. Examples of decorative displays include one or more of a pattern, picture, design, or the like. Examples of informative displays include one or more of a name, title, number, other alphanumeric code, or the like. In various embodiments where all or a portion of the graphics layer 114 includes identification information, all or a portion of the graphics layer 114 may be considered as a type of optically readable identification layer 112. The information provided by the informative display may be the same as all or a portion of the information provided by an optically readable identification layer or may otherwise correspond to all or a portion of the information provided by an optically readable identification layer. In other embodiments, information provided by the graphics layer may be different than information provided by an optically readable identification layer. Information provided by a graphics layer and an optically readable identification layer may be related. For example, a graphics layer may display a model name and/or pictorial representation corresponding to the object 101, while the optically readable information layer may include a serial number of the object 101. In various embodiments, for example, the graphics layer may include an identification of a type of product corresponding to the object 101, while the optically readable information layer may include information identifying a specific member of a population of such products. The above examples are provided by way of illustration only and not limitation, as other arrangements may be employed. Further still, in some embodiments, the optically readable identification layer 112 and the graphics layer 114 may be incorporated into a common layer or sub-layers.

The graphics layer 114, for example, may be printed. In some embodiments, the graphics layer 114 may be printed on the carrier layer 110 but remain with one or more additional layers such as an adhesive layer after application of the transferable film 100 to the object 101 and removal of the carrier layer 110 (e.g., release of the carrier layer 110 via heating). In various embodiments, the graphics layer 114 may include sub-layers or be applied sequentially and/or as more than one layer. Various sub-layers of a graphics layer 114 may be arranged side by side, overlapping partially along the depth of the transferable film 100, or on top of each other (e.g., an upper layer may include a transparent window or portion, a translucent portion, or the like allowing all or a portion of a lower level to be seen). With the graphics layer 114 positioned on top of the circuit portion 118 (e.g., farther away from the object 101 or closer to an observer), the graphics layer may act to obscure or conceal the circuit portion 118 from view of an observer. The graphics layer 114, in some embodiments may cover substantially the entire area of the carrier layer 110, while in other embodiments may cover only a portion of the carrier layer 110. The design and positioning of the graphics layer 114 may be configured to cooperate with the design and the positioning of the optically readable identification layer 112. For example, the graphics layer 114 may be configured to have a transparent window corresponding to the positioning of an optically readable code. As another example, the graphics layer 114 may include a solid color background configured to correspond with the positioning of an optically readable code and to provide for improved ease of viewing, scanning, recording, or the like of the optically readable code (e.g., to provide contrast, such as a white background to an optically readable code presented in black or other dark tones). As yet one more example, the graphics layer may be sized and positioned so as to not overlap with the optically readable identification portion 112. In various embodiments, the graphics layer may be printed or otherwise applied to the carrier layer or a release coat associated with the carrier layer; to the top coat (see, e.g., FIG. 2), or to the top coat along with the optically readable identification layer (see, e.g., FIG. 1); or the like.

In the illustrated embodiment, the circuit adhesive layer 116 is positioned beneath the graphics layer 114. The circuit adhesive layer 116 may be configured to secure, mount, affix, or otherwise adhere the circuit portion 118 to one or more portions of the transferable film 100, such as the graphics portion 114. In various embodiments, the circuit adhesive layer 116 may be applied to all of the graphics layer 114 or, in other embodiments, just to a portion of the graphics layer 114, such as a portion of the graphics layer 114 corresponding to a positioning of the circuit portion 118 (e.g., in certain embodiments where the circuit portion 118 defines a substantially smaller area than the graphics layer 114). As depicted in FIG. 1, the circuit adhesive layer 116 may be applied to the graphics layer 114. As another example, a circuit adhesive layer may be applied to a top coat, a graphics layer, and an optically readable identification layer, as depicted in FIG. 2.

Returning to FIG. 1, the depicted circuit portion 118 is positioned beneath (e.g., closer to the object 101 or farther from the view of an observer) than the circuit adhesive layer 116 to which it is adhered and the graphics layer 114, as well as the top coat layer 110. It should be noted that all or a portion of the circuit portion may be formed or applied as one or more layers or sub-layers. For example, the circuit portion 118 may include individual circuits or sub-circuits formed on different layers or sub-layers that are coupled to each other or otherwise operably connected. In some embodiments, the various layers or sub-layers may be applied sequentially to already present portions of the transferable film 110. Alternatively or additionally, various layers or sub-layers of the circuit portion 118 may first be joined together to form a sub-assembly which is subsequently added to already present portions of the transferable film 100. The circuit portion 118 may include an integrated circuit that includes a logic circuit, with the IC operably coupled to one or more additional components, such as an RFID antenna. In various embodiments, the circuit portion 118 may be configured to communicate with an observer utilizing near field communication (NFC) devices and/or protocols. In various embodiments, the logic circuit (and/or one or more aspects of an integrated circuit) may be a thin flexible circuit. As the circuit portion 118 is disposed beneath the graphics portion 114 in the illustrated embodiment relative to an observer, the circuit portion 118 may be entirely or partially concealed, obscured, blocked, or shielded from view, so that the presence of the circuit portion 118 is not noticeable or detectable to the naked eye. It should be noted that an RFID antenna is just one example of an additional or auxiliary component that may be used in conjunction with a logic circuit or IC. Additional or alternative components or functionality may be provided by the circuit portion 118 in various embodiments.

The circuit portion 118 may be coordinated with or otherwise correspond to information conveyed by or contained within an optically readable information code (or portion thereof) of the optically readable information layer 112. For example, a serial or tracking number of a particular circuit portion may be read or determined prior to printing or applying the optically readable information layer 112. A particular optically readable information code (or portion thereof) may be determined based on the serial or tracking number of the particular circuit portion to be added to a given film or foil, with the optically readable information code that corresponds to the particular circuit portion printed on or applied to, for example, the topcoat of the given film or foil before the addition of the particular circuit portion.

In various embodiments, the circuit portion 118 may be configured as a transferable film that is applied to an already deposited, printed, applied, or otherwise present portion of the transferable film 110. In some embodiments, the circuit portion 118 may be a film that is applied to a circuit adhesive layer 116. As another example, the circuit portion may be configured as part of a film that includes the circuit portion as well as an adhesive layer, with the adhesive layer configured to secure, affix, or otherwise adhere the film including the circuit portion to another aspect of the transferable film 100, such as the graphics layer 114.

In some embodiments, the circuit portion 118 may be configured to store, update, and/or communicate identification and/or tracking information regarding the circuit portion 118, the transferable film 100, and/or the object 101. Additionally or alternatively, the circuit portion 118 may be configured for virtually any functionality that may be provided by a circuit and/or integrated circuit within the size, expense, and power constraints imposed by a given application and/or being embedded within a transferable film.

In various embodiments, the circuit portion 118 may be programmed or otherwise configured before being applied or added to the transferable film 100. Alternatively or additionally, the circuit portion 118 may be programmed or otherwise configured after being applied or added to the transferable film 100. For example, in some embodiments, a circuit may be imprinted so that the circuit includes no connections. Then, semi-conductive material of the circuit may be digitally laser modified to form conductive connections to program in a serial or tracking number that can be later read. As another example, a circuit may be imprinted so that all conductive connections are made. Then, conductive material of the circuit may be digitally laser modified to eliminate certain connections between predetermined paths to produce distinct serial or tracking numbers. In various embodiments, programming may occur via digitally printing distinct conductive interconnects for each circuit using conductive inks. In some embodiments, programming of an integrated circuit or logic circuit may be begun and/or completed by a supplier of a heat transfer film including the integrated circuit or logic circuit. In various embodiments, programming of an integrated circuit or logic circuit may be completed by a purchaser or user of a heat transfer film just prior to adding a final adhesive layer (e.g., adhesive layer 104) and applying the transferable film 100 to an object being decorated or otherwise labeled (e.g., object 101).

In the illustrated embodiment, the adhesive layer 104 is the portion of the transferable film 100 positioned most proximately to the object 101 when the transferable film 100 is applied to the object 101. The adhesive layer 104 may be configured to affix, secure, mount, or otherwise adhere the transferable film 100 to an object, and to maintain the transferable film 100 adhered to the object 101 when the carrier layer 102 is removed from the transferable film 100. For example, after the transferable film 100 is applied to the object 101, the carrier layer 102 may be removed (e.g., via a heat release mechanism), with the remaining portions of the transferable film 100 remaining affixed to the object 101 directly or indirectly via the adhesive layer 104.

In some embodiments, the adhesive layer 104 may be added to the transferable film 100 at or about the same time as the other portions of the transferable film 100 are added (e.g. as part of a generally continuous line or process). In some embodiments, an adhesive layer may be added to the transferable film 100 at a different time or location (e.g., a different facility such as a facility of a customer that has acquired the transferable film 100 from a supplier). For example, the adhesive layer 104 (or an additional adhesive layer) may be applied to the transferable film shortly before the transferable film 100 is applied to the object 101.

FIG. 2 shows a sectional schematic view of a transferable film 200. In FIG. 2, in contrast to FIG. 1, the transferable film 200 is depicted with various layers applied, joined, or otherwise attached to each other. The transferable film 200 may be generally similar in respects to the transferable film 100 discussed elsewhere herein. For example, the transferable film 200 includes an intermediate portion 206 interposed between a carrier layer 202 and an adhesive layer 204. As depicted in FIG. 2, the transferable film 200 includes a release layer 208. A release layer such as release layer 208 may be incorporated into embodiments such as the transferable film 100, or may be omitted in various embodiments. In certain embodiments, a top coat layer may have release properties for facilitating the release or removal of a carrier layer or film from a transferable film or foil after application of the transferable film or foil (e.g., via a heat release mechanism as part of a heat transfer or hot stamping process).

In FIG. 2, some layers or aspects of the transferable film 200 are depicted as overlapping in depth through the thickness of the transferable film 200. To apply or affix the transferable film 200 to an object, the transferable film 200 may be positioned as desired relative to the object, with the adhesive layer 204 oriented facing toward the object to which the transferable film 200. As used in conjunction with FIG. 2, a given layer described as lower than or beneath a different layer or layers may be understood as being disposed, positioned, or oriented more closely to an object to which a transferable film or foil will be applied than layers described as higher than or above the given layer. Similarly, a given layer described as higher than or above a different layer or layers may be understood as being disposed, positioned, or oriented more closely to an observer of the transferable film or foil or an object to which the transferable film or foil has been applied than layers described as lower than or beneath the given layer. Thus, a higher or uppermost layer (or layers) appears more visually prominent to an observer than a lower or lowermost layer (or layers). To the extent a higher layer is opaque and covers a lower layer, the higher layer may be obscure the lower layer to an observer. Thus, for example, all or a portion of a top coat layer may be configured as transparent or substantially transparent to allow an observer to see all or a portion of a lower layer or layers, such as an identification layer and/or a graphics layer. Similarly, all or a portion of a graphics layer may be substantially opaque so as to visually shield a lower layer (or layers) or portion (or portions), such as in integrated circuit from an observer.

The embodiment depicted in FIG. 2 is shown with the carrier layer 202 attached to the top coat 210 and still a part of the transferable film 200. However, the carrier layer 202 may be removed from the transferable film 200, for example after the transferable film has been applied or otherwise affixed to an object.

The transferable film includes a carrier layer 202, an adhesive layer 204, and an intermediate portion 206. The intermediate portion 206 includes a release layer 208, a top coat layer 210, an identification layer 212, a graphics layer 214, a circuit adhesive layer 216, and a circuit portion 218.

The carrier layer 202 may be configured substantially similar to the carrier layer 102 discussed herein. For example, the carrier layer 202 may be configured as a film configured to be releaseable (e.g., via a heat release mechanism) or otherwise removable from the transferable film 200. Thus, the carrier layer 202 may be considered as a temporary portion of the transferable film 200, in that the transferable film 200 may be completely formed and include the carrier layer 202 (e.g., before application to an object), or may be completely formed and not include the carrier layer 202 (e.g., after the transferable film 200 has been applied to an object and the carrier layer 202 released or otherwise removed). Other aspects of the transferable film 200 (e.g., the circuit portion 218) may be considered permanent portions of the transferable film 200, as the transferable film 200 may not be considered completely formed without such permanent portions.

In the embodiment depicted in FIG. 2, the transferable film 200 includes a release coat 208 disposed immediately beneath (e.g., closer to an object to which the transferable film 200 is to be applied or farther from an observer of the transferable film 200 in a desired orientation) the carrier layer 202. Thus, in the illustrated embodiment, the release coat 208 is interposed between the top coat 210 and the carrier layer 202. The release coat 208 of the illustrated embodiment is configured to facilitate the release of the carrier layer 202 from the transferable film 200 under specific conditions (e.g., a given amount of heat and/or duration of time of heat application). In various embodiments, the release coat 208 may form a releaseable assembly with the carrier layer 202, with the release coat 208 being released or removed from the transferable film 200 with the carrier film 202 after the transferable film 200 has been applied to an object. In some embodiments, the release coat 208 may remain with the transferable film 200 after removal of the carrier layer 202. The release coat 208, for example, may be made from an acrylic or other polymer.

The top coat 210 may be configured substantially similarly in respects to the top coat 110 discussed elsewhere herein. The identification layer 212 is configured to provide identification information corresponding to the transferable film 200, the circuit portion 218, and/or an object to which the transferable film is to be applied or has been applied. For example, the identification layer 212 may be configured substantially similarly in respects to the optically readable identification layer 112 discussed elsewhere herein, and may be configured as an optically readable identification layer displaying an optically readable code such as a bar code.

The graphics layer 214 may be configured to provide a decorative display and/or an informative display, such as one or more of a picture or design, a logo, slogan, name, pattern, border, solid color, number, alphanumeric code, or the like. The graphics layer 214 may be configured substantially similarly in respects to the graphics layer 114 discussed elsewhere herein. It may be noted that in FIG. 2, the graphics layer 214 is depicted as being applied only to the top coat layer 210. However, in other embodiments that graphics layer 214 may be applied additionally or alternatively to one or more other layers. As one example, in some embodiments, a graphics layer may be printed or otherwise applied directly to a carrier layer or film. As just one more example, in various embodiments, a graphics layer may be applied to an identification layer (e.g., the graphics layer may have a window corresponding to the identification layer or a portion configured to provide a desired contrast to an above-situated identification layer) in addition to a top coat or carrier layer. The graphics layer 214 may be configured to visually block, shield, or obscure the circuit portion 218 from the sight of a human observer, but to allow passage of signals so that the circuit portion 218 may be communicatively coupled with an external device (e.g., via RFID, NFC, or the like).

The circuit adhesive layer 216 of the embodiment depicted in FIG. 2 is configured to adhere, secure, join, mount, or otherwise affix the circuit portion 218 to one or more other aspects of the transferable film 200, such as the graphics layer 214. The circuit adhesive layer 216 may be configured substantially similarly in respects to the circuit adhesive layer 116 discussed elsewhere herein. As depicted in FIG. 2, the circuit adhesive layer 216 covers (from the perspective of the bottom of the transferable film 200) or is applied to top coat 210, the identification layer 212, and the graphics layer 214. Other arrangements may be utilized in various embodiments, such as for example, a circuit adhesive layer that is applied to fewer layers, different layers, or different combinations of layers. For example, in some embodiments, the circuit adhesive layer 216 may be applied to (or cover) all or a portion of the graphics layer 214, but not be applied to the top coat layer 210 or the identification layer 212.

The circuit portion 218 may be configured substantially similarly in respects to the circuit portion 118 discussed elsewhere herein. For example, the circuit portion 218 may include an RFID antenna to provide communicative capability with an observer. In various embodiments, the circuit portion 218 may be configured to communicate with an observer utilizing NFC devices and/or protocols. The circuit portion 218 in the embodiment depicted in FIG. 2 may be positioned so that it is disposed directly beneath all or a portion of the graphics layer 214 so that the circuit portion 218 is blocked or obscured from the sight of a human observer of the transferable film 200 or an object to which the transferable film 200 has been applied or otherwise affixed. Thus, the circuit portion 218 may not be visually apparent to a human observer, but may communicate with a processor or the like (e.g., via a RFID antenna).

In the embodiment depicted in FIG. 2, the adhesive layer 204 is the portion of the transferable film 200 positioned most proximately to an object to which the transferable film is to be applied (or has been applied) and oriented toward the object when the transferable film 200 is applied to the object. The adhesive layer 204 may be configured substantially similarly to the adhesive layer 104 discussed elsewhere herein. For example, the adhesive layer 204 may be configured to affix, secure, mount, or otherwise adhere the transferable film 200 to an object, such as a package or a product. In various embodiments, the adhesive layer 204 may be added to the transferable film 200 at or about the same time as the other portions of the transferable film 200 are added. In some embodiments, the adhesive layer 204 may be added to the transferable film 100 at a different time or location. For example, the transferable film 200 may be assembled or constructed at a first facility or facilities, and then transferred to a different facility for application to an object, with the adhesive layer 204 (or an additional adhesive layer) applied to the transferable film 200 shortly before the transferable film 200 is applied to an object.

Thus, a circuit may be provided by various embodiments for convenient transfer to an object. Embodiments provide for the cost effective mounting of a circuit (e.g., a circuit including an integrated circuit) to a package or product. Embodiments provide for flexibility, functionality, and/or performance of transferable films by the addition, incorporation, or embodiment of a logic circuit to the transferable film. For example, embodiments provide for a label that may be heat transferable to a package or product that provides for improved readability or other acquisition of identification information. For example, identification information may be acquired more quickly, more reliably, or the like. Embodiments provide for a transferable and flexible multilayered film with a logic circuit embedded therein which may be conveniently, reliably, and economically applied, such as by a heat transfer process. In various embodiments, the capability to digitally print short-run late-stage decorations such as logos or other graphics, may be provided or accommodated.

FIG. 3 shows a flowchart of a method 300 for providing a transferable film including a circuit. The method 300 may be used in conjunction, for example, with one or more embodiments described herein, and/or used to provide a transferable film such as transferable films 100, 200 shown in FIGS. 1 and 2, respectively, and described herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. Generally, the method 300 includes the provision or acquisition of a carrier layer (e.g., carrier layer 102), and the addition thereto of an intermediate portion (e.g., intermediate portion 106) and an adhesive layer (e.g., adhesive layer 104). In various embodiments, a portion or layer may be provided in one or more steps (e.g., an intermediate portion may be added by the application of a plurality of layers or portions applied sequentially). Further, one or more layers or other aspects may be formed into a subassembly and then added to other assemblies or subassemblies. By way of example and not limitation, in various embodiments, all or a portion of the intermediate portion may be formed (e.g., as a foil) as a whole or as a unit before application to a carrier layer or to another layer directly or indirectly joined or affixed to the carrier layer, and/or a circuit and circuit adhesive layer may be pre-formed and added as a unit to a graphics layer. The transferable film may be formed in one or more locations. For example, in some embodiments, the transferable film may constructed or assembled in a first location or locations without the adhesive layer configured to be closest to an object receiving the transferable film, with the adhesive layer configured to be closest to the object receiving the transferable film being joined or added to the transferable film at or near the time of application of the transferable film to the object. In various embodiments, certain steps depicted in FIG. 3 (e.g., steps 304-320) may be considered as sub-steps of a step of adding an intermediate portion to a carrier layer. In some embodiments, various layers may be applied by coating, printing, application as a film or foil, or the like.

At 302, a carrier layer or film (e.g., carrier layer 102, 202) is provided. The carrier layer film may be constructed, for example, from a polymeric film, such as a PET film or a BoPET film. The carrier layer may be configured to provide a substrate to which additional layers or portions of the transferable film are mounted or affixed directly or indirectly. The carrier layer may also be configured (e.g., with the addition of a release layer and/or a top coat having release properties) to be releaseable or otherwise removable from the transferable film after the transferable film is affixed to an object. For example, the carrier layer may be released from the transferable film as part of a heat transfer through the application of a specific amount of heat and/or duration of heat application.

At 304, a release coat (e.g., release layer 208) may be applied to the carrier layer. For example, the release coat may be coated onto one side of the carrier film (e.g., the side of the carrier film that will be oriented toward an object to which the transferable film is to be applied). The release coat may be configured to have release properties to assist in the release or removal of the carrier film.

At 306, a top coat (e.g., top coat layer 110, 210) is applied or otherwise added to the carrier layer. For example, the top coat may be coated onto the release layer that has been previously applied to the carrier film at 304. The top coat may be configured to protect lower-positioned (e.g., closer to an object to which the transferable film is to be applied or to which the transferable film has been applied) layers or aspects of the transferable film. The top coat may be configured to have release properties to assist in the release or removal of the carrier film. In various embodiments, the top coat may be applied directly to the carrier layer. For example, a release coat may be omitted (or provided with the top coat) and the top coat may be configured to have release properties to assist in the release or removal of the carrier film.

At 308, an identification layer (e.g., optically readable identification layer 112, identification layer 212) is applied to the carrier layer. In various embodiments, the identification layer may be applied directly to the carrier layer. In the embodiment depicted in FIG. 3, the identification layer is applied indirectly to the carrier layer via application to the top coat (which has in turn been previously affixed to the carrier layer indirectly via the release coat). The identification layer may display or provide an identification code, such as a serial number, bar code, QR code, or the like. The identification layer in the illustrated embodiment is configured to correspond to a circuit portion that will be embedded or disposed within the particular transferable film. The identification layer may be applied to the carrier layer or added to the transferable film via a series of steps, such as steps 310, 312, 314 depicted in FIG. 3.

At 310, identification information corresponding to a circuit portion (e.g., circuit portion 118, circuit portion 218) is acquired. For example, identification information may be obtained via an RFID antenna of the circuit portion, via a NFC device and/or protocol, or the like. In various embodiments, a corresponding film portion (e.g., a carrier film to which one or more of a release coat or top coat may have been added) to which the circuit portion will be affixed is identified. For example, a serial number, tracking number, or other identification code or identifier may be read from an integrated circuit that will be attached in a known sequence of circuits to a particular film or foil in a corresponding known sequence of films or foils.

At 312, optically readable code information is determined. In the embodiment depicted in FIG. 3, a code is determined or configured to correspond to a serial number or other tracking information identified at 310. The optically readable code, for example, may be a bar code, QR code, or other two dimensional or matrix-type code, or the like.

At 314, the optically readable code is applied to the transferable film, for example either directly or indirectly to the carrier layer. For example, the optically readable code may be printed on the carrier layer or the top coat. In various embodiments, the optically readable code may be digitally printed.

At 316, a graphics layer (e.g., graphics layer 114, 214) is applied. The graphics layer may be applied in some embodiments directly to the carrier layer and in other embodiments indirectly to the carrier layer via application to one or more layers (e.g., top coat, identification layer) that have previously been applied directly or indirectly to the carrier layer. The graphics, for example, may be printed. In some embodiments, the graphics layer may be sized and positioned so that the graphics layer does not laterally overlap with or coat an identification layer, while in other embodiments the graphics layer may laterally overlap or coat the identification layer, and may provide a background (e.g., a solid color differing from a color of a code representation on the identification layer) configured to provide a contrast for improved readability of the identification layer. The graphics layer may include one or more of graphics (e.g., a picture, pattern, logo, or the like), metal effects, solid colors, or the like. All or a portion of the graphics layer may be substantially opaque so as to visually shield, obscure, or conceal a circuit portion disposed beneath the graphics layer (or portion thereof). In various embodiments, the graphics layer may be composed of layers or sub-layers.

At 318, a circuit portion adhesive layer (e.g., adhesive layer 116, 216) is applied. For example, the circuit portion adhesive layer may be coated over one or more of the graphics layer (which may be printed directly or indirectly to the carrier layer), the identification layer (which may be digitally printed directly or indirectly to the carrier layer), or the top coat (which may be coated directly or indirectly to the carrier layer). The circuit portion adhesive layer may be coated, in some embodiments, directly on one or more portions of the carrier layer to which a previous layer has not already been applied. The circuit adhesive layer is configured to secure the circuit portion to an aspect, layer, and/or portion of the transferable film, and thus may be applied at least in a location or locations corresponding to the subsequent placement of the circuit portion. In some embodiments, the circuit adhesive layer may be formed as a sub-assembly with the circuit portion, with the circuit adhesive layer and the circuit portion applied at the same time, for example, to the graphics layer (or a portion thereof).

At 320, a circuit portion (e.g., circuit portion 118, circuit portion 218) is added to the carrier layer, for example, by being affixed or adhered to the graphics layer via the circuit portion adhesive layer. The circuit portion, in some embodiments, may be applied concurrently with the circuit adhesive layer as a subassembly. In some embodiments, the circuit may be applied from a releasable carrier film. The circuit portion may be applied in a single step or may be applied in parts in a series of steps or sub-steps. In various embodiments, the circuit portion may be programmed as discussed above in connection with the transferable film 100 and/or the transferable film 200. For example, in some embodiments, the circuit portion may be pre-programmed partially or entirely by a supplier or distributor of a transferable film. In some embodiments, the circuit portion may be programmed entirely or partially subsequent to distribution of the transferable film, for example, by a purchaser or other user of a transferable film before affixation of a final adhesive layer and application of the transferable film to an object by the purchaser or other user. The circuit portion may be positioned beneath the graphics layer so that the circuit portion is visually obscured or blocked by the graphics layer applied at 316.

At 322, an adhesive layer (e.g., adhesive layer 104, 204) is applied. The adhesive layer may be applied, for example, by coating a layer of adhesive over the circuit adhesive layer applied at 318 and the circuit portion affixed at 320, along with any other surfaces not previously coated by the circuit adhesive layer. Alternatively or additionally, an additional layer of pigment ink may be coated onto the circuit adhesive layer and/or the integrated circuit. The adhesive layer is configured to adhere the transferable film to an object, such as a product or package. The adhesive layer, in some embodiments, may be applied at substantially the same time as other layers. In some embodiments, the adhesive layer (or an additional adhesive layer) may be applied at a subsequent time (and may be applied at a different location). For example, the transferable film may be delivered by a manufacturer of the transferable film to a customer or other user, and the customer or other user may apply the adhesive layer (or an additional adhesive layer) at or near the time of application of the transferable film to an object. In various embodiments, a customer or other user may program the circuit portion, and then add the adhesive layer to the transferable film and apply the transferable film to an object.

FIG. 4 shows a flowchart of a method 400 for applying a transferable film to an object in accordance with an embodiment, and FIG. 5 provides a schematic depiction of the application of a transferable film 500 to an object 501 in accordance with an embodiment. The method 400 may be used in conjunction with other embodiments (e.g., transferable film 100, transferable film 200, method 300) discussed elsewhere herein. The method 400 may be used in conjunction, for example, with one or more embodiments described herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion.

At 402, a transferable film (e.g., transferable film 100, 200) is provided. In some embodiments, the transferable film may be provided with a final adhesive layer incorporated therein or otherwise attached thereto or associated therewith. In certain other embodiments, a transferable film may be provided without a final adhesive layer (e.g., an adhesive layer that will be positioned adjacent to and in contact with an object to which the transferable film will be applied), and the final adhesive layer may be added to or joined with the transferable film at or near the time of application to an object. In FIG. 5, a transferable film 500 at a first stage 510 of a process 505 is depicted schematically in position to be applied to an object 500, with a final adhesive layer positioned at the bottom 503 (in the sense of FIG. 5) of the transferable film 500.

Returning to FIG. 4, at 404, the transferable film is applied to the object. The transferable film includes a circuit portion, for example including an integrated circuit. The transferable film may be applied to the object in various embodiments via heat. For example, the transferable film may be applied to the object as part of either a heat transfer or hot stamped foil process using a combination of heat, time and pressure to apply the transferable film to the object.

At 406, a carrier layer of the transferable film is removed. The carrier layer may be released or removed from the transferable film as part of a heat facilitated application process. In various embodiments, a transferable film may have a release coat and/or a top coat with release properties positioned proximate the carrier layer to facilitate the release or removal of the carrier layer after the transferable film is applied to an object. Removal of a carrier layer 502 from a transferable film 500 that has been applied to an object 501 is depicted schematically at stage 520 of a process depicted in FIG. 5.

At 408, identification information corresponding to a circuit portion is obtained. For example, identification information, such as a serial number or other identifier of a logic circuit may be read via use of an RFID antenna, a NFC device or protocol, or the like. In various embodiments, the identification information may provide general identification information corresponding to a type, style, model, batch, production run, or the like of a given circuit portion and/or logic circuit, and/or specific identification information corresponding to the particular individual given circuit portion and/or logic circuit. In FIG. 5, a reader 532 is depicted as reading identification information from a circuit portion of the transferable film 500 at stage 530.

Returning to FIG. 4, at 410, the object to which the transferable film including a circuit portion has been applied is associated with the circuit portion. For example, data from an integrated circuit embedded within the transferable film may be read (e.g., at 408). Further, a serial number, tracking number, or other identifier of the object to which the transferable film has been applied may be retrieved, obtained, or otherwise acquired. The time and date of the transfer of the film may be logged. The time and date of the transfer as well as one or more identifiers (e.g., serial numbers) may be recorded into a database. In various embodiments, the circuit portion may be tested to verify that the circuit portion is operating properly.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While relative dimensions described herein are intended to define the parameters of the inventive subject matter, they are by no means limiting and are example embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. For example, methods (or portions thereof) disclosed herein (e.g., method 300, method 500) may be performed by appropriately programmed computers or processors (e.g., in conjunction with a tangible, non-transitory computer readable medium including one or more software modules configured to direct a processor to perform one or more steps of a method of a given embodiment). Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

What is claimed is:

1. A transferable film comprising:
a carrier layer configured to receive one or more additional layers and to be releasable from the one or more additional layers temporally proximate to an application of the transferable film to an object; and
an intermediate portion comprising the one or more additional layers and a circuit portion, wherein the one or more additional layers comprise a graphics layer, the intermediate portion configured for application thereto of an adhesive layer whereby the intermediate portion is configured to be interposed between the carrier layer and the adhesive layer, the adhesive layer configured to adhere to the object for the application of the transferable film to the object.

2. The transferable film of claim 1, wherein the circuit portion comprises an integrated circuit, the integrated circuit comprising a logic circuit.

3. The transferable film of claim 2, wherein the integrated circuit is a thin, flexible integrated circuit.

4. The transferable film of claim 2, wherein the circuit portion comprises a radiofrequency identification (RFID) antenna operably connected to the logic circuit, and wherein the intermediate portion includes an optically readable code, the optically readable code configured to correspond to information provided by the logic circuit.

5. The transferable film of claim 1, wherein the circuit portion is interposed between the graphics layer and the adhesive layer, whereby the circuit portion is configured to be positioned beneath the graphics layer relative to an observer of the object when the transferable film is applied to the object, whereby the circuit portion is not visible to the observer.

6. The transferable film of claim 1, wherein the intermediate portion comprises a circuit adhesive layer, the circuit adhesive layer interposed between the graphics layer and the circuit portion and configured to adhere the circuit portion to the graphics layer.

7. The transferable film of claim 1, wherein the intermediate portion comprises a protective top coat layer positioned adjacent the carrier layer.

8. The transferable film of claim 1, wherein the transferable film is configured as a heat transferable film.

9. The transferable film of claim 1, wherein the transferable film is configured as a hot stamped foil.

10. A method for providing a transferable film, the method comprising:
providing a carrier layer, the carrier layer configured to be releasable from the transferable film temporally proximate to an application of the transferable film to an object; and
adding an intermediate portion to the carrier layer, the intermediate portion comprising one or more additional layers and a circuit portion, wherein the one or more additional layers comprise a graphics layer, the intermediate portion configured to receive an adhesive layer, wherein the intermediate portion is interposed between the carrier layer and the adhesive layer, the adhesive layer configured to adhere to an object during the application of the transferable film to the object.

11. The method of claim 10, wherein the circuit portion comprises an integrated circuit operably connected to a radiofrequency (RFID) antenna, wherein the method further comprises:
configuring an optically readable code to correspond to the integrated circuit; and
providing the optically readable code as part of the intermediate portion.

12. The method of claim 11, further comprising:
acquiring identification information corresponding to the integrated circuit;
identifying a corresponding film portion that is scheduled to receive the integrated circuit;
determining optically readable code information to correspond to the integrated circuit; and
applying the optically readable code on the corresponding film portion, the optically readable code corresponding to the optically readable code information corresponding to the integrated circuit.

13. The method of claim 10, wherein the adding an intermediate portion comprises applying the graphics layer to at least one of the carrier layer or a layer that has previously been applied to the carrier layer, and applying the circuit portion after the applying the graphics layer, whereby the circuit portion is configured to be positioned beneath the graphics layer relative to an observer of the object when the transferable film is applied to the object, whereby the circuit portion is not visible to the observer.

14. The method of claim 13, further comprising:
applying a circuit adhesive layer to the graphics layer; and
applying the circuit portion to the circuit adhesive layer.

15. The method of claim 13, wherein the adding the intermediate portion comprises applying a top coat layer to the carrier layer, the top coat layer configured to protect one or more additional aspects of the intermediate portion.

16. A method of providing an object with a transferable film including a circuit, the method comprising:
providing a transferable film, the transferable film comprising a releasable carrier layer, an adhesive layer configured to adhere the film to the object, and an intermediate portion interposed between the carrier layer and the adhesive layer, the intermediate portion including a circuit and one or more additional layers, wherein the one or more additional layers comprise a graphics layer;
applying the transferable film, with the adhesive layer oriented toward the object, to the object;
removing the carrier layer from the transferable film;
acquiring identification information corresponding to the circuit; and
associating the object with the identification information.

17. The method of claim 16, wherein the transferable film is configured as a heat transferable film.

18. The method of claim 16, wherein the transferable film is configured as a hot stamped foil.

19. The method of claim 16, wherein the applying the transferable film comprises applying the transferable film with the circuit interposed between the object and the graphics layer, whereby the circuit is not visible to an observer.

20. The method of claim 16, wherein the circuit comprises a radiofrequency identification (RFID) antenna operably connected with a logic circuit, and wherein the acquiring identification information corresponding to the circuit comprises acquiring the identification information via the RFID antenna.
